(19) United States
(12) Patent Application Publication
(10) Pub. No.: US 2006/0139947 A1
(43) Pub. Date: Jun. 29, 2006

(54) Diffusion plate and backlight module using the same

(75) Inventors: Che-Kuei Mai, Miao-Li (TW); Hong Han, Shenzhen (CN); Ching-Huang Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,263

(22) Filed: Dec. 23, 2005

(30) Foreign Application Priority Data
Dec. 28, 2004 (TW) 93221034

(51) Int. Cl. F21V 7/04

(52) U.S. Cl. 362/606

(57) ABSTRACT

A diffusion plate (20) includes a substrate (26) and a diffusion layer (22) disposed at a surface of the substrate. The substrate defines a plurality of through holes (28). A portion of light beams from an associated light source is reflected and refracted at walls of the substrate surrounding the through holes, and subsequently is diffused by the diffusion layer to display images. Another portion of the light beams propagates directly to the diffusion layer via the through holes, thereby avoiding partial absorption within the substrate. Thus the overall utilization of light beams is increased. A backlight module includes, for example, a light guide plate having a light incident surface and a light emitting surface, a light source disposed adjacent to the light incident surface, and the above-described diffusion plate disposed adjacent to the light emitting surface.

### FIELD OF THE INVENTION

The present invention relates to diffusion plates for backlight modules typically used in liquid crystal display devices, and more particularly to a diffusion plate having a plurality of through holes.

### GENERAL BACKGROUND

Generally, a backlight module includes a light source, a light guide plate, a diffusion plate, and a reflection plate. The diffusion plate is a main element in a typical backlight module.

As shown in FIG. 5, a typical diffusion plate 10 includes a diffusion layer 12, a substrate 16, and an anti-electrostatic layer 14 disposed in that order from top to bottom. Light beams passing through the diffusion plate 10 are diffused by the diffusion layer 12. The anti-electrostatic layer 14 is to protect the diffusion plate 10 from electrostatic damage. The substrate 16 supports the diffusion layer 12, and is made from polyethylene terephthalate (PET), polycarbonate (PC), or polymethyl methacrylate (PMMA).

However, the above-mentioned typical diffusion plate 10 absorbs a portion of the light beams because of the characteristics of its materials and structure. Thus, the utilization of light beams and the brightness of the diffusion plate 10 are decreased.

What is needed, therefore, is a diffusion plate that overcomes the above-described deficiencies.

### SUMMARY

In a preferred embodiment, a diffusion plate includes a substrate and a diffusion layer disposed at a surface of the substrate. The substrate defines a plurality of through holes.

In use, a backlight module includes a light guide plate having a light incident surface and a light emitting surface, a light source disposed adjacent to the light incident surface, and the diffusion plate disposed adjacent to the light emitting surface.

A portion of light beams from an associated light source is reflected and refracted at walls of the substrate surrounding the through holes, and subsequently is diffused by the diffusion layer to display images. Another portion of the light beams propagates directly to the diffusion layer via the through holes, thereby avoiding partial absorption within the substrate. Thus the overall utilization of light beams is increased.

Other advantages and novel features will become more apparent from the following detailed description when taken in conjunction with the accompanying drawings.

### BRIEF DESCRIPTION OF THE DRAWINGS

FIG. 1 is a schematic, side cross-sectional view of part of a diffusion plate according to a first embodiment of the present invention.

FIG. 2 is a schematic, side cross-sectional view of part of a diffusion plate according to a second embodiment of the present invention.

FIG. 3 is a schematic, side cross-sectional view of part of a diffusion plate according to a third embodiment of the present invention.

FIG. 4 is a schematic, side cross-sectional view of a backlight module employing the diffusion plate of FIG. 3.

FIG. 5 is a schematic, side cross-sectional view of a conventional diffusion plate.

### DETAILED DESCRIPTION OF PREFERRED EMBODIMENTS

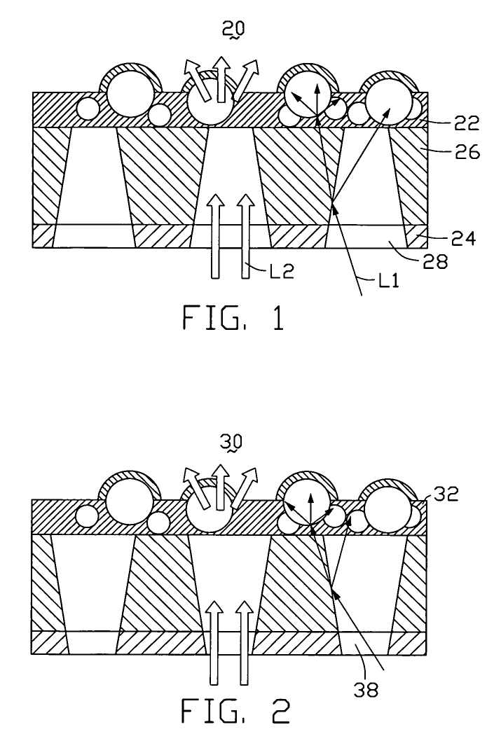

FIG. 1 is a schematic, side cross-sectional view of a diffusion plate 20 according to a first embodiment of the present invention. The diffusion plate 20 includes a diffusion layer 22, a substrate 26, and an anti-electrostatic layer 24 disposed in that order from top to bottom. The diffusion layer 22 is made from polyethylene terephthalate (PET) or polycarbonate (PC), and has a plurality of diffusion particles (not labeled) embedded therein. The diffusion particles have a diameter in a range of 5˜30 μm, and are made from polymethyl methacrylate (PMMA) or melamine resin. The substrate 26 is made from a highly transparent material, such as PET, PC, or PMMA. The anti-electrostatic layer 24 protects the diffusion plate 20 from electrostatic damage.

A plurality of through holes 28 is defined in the combined substrate 26 and anti-electrostatic layer 24. The through holes 28 are cone-shaped, with the small ends thereof being adjacent to the diffusion layer 22. In use, a portion (e.g., labeled L1) of light beams from a light source (not shown) passes through the through holes 28 of the anti-electrostatic layer 24 and reaches walls of the substrate 26 surrounding the through holes 28. The light beams L1 are reflected and refracted at the walls, and propagate to the diffusion layer 22. The light beams L1 are then diffused by the diffusion layer 22 to display images. Another portion (e.g., labeled L2) of the light beams from the light source propagate directly to the diffusion layer 22 via the through holes 28, thereby avoiding absorption within the anti-electrostatic layer 24 or the substrate 26. Thus the overall utilization of light beams is increased.

FIG. 2 is a schematic, side cross-sectional view of a diffusion plate 30 according to a second embodiment of the present invention. The diffusion plate 30 is similar to the diffusion plate 20 of FIG. 1. However, cone-shaped through holes 38 are defined with the large ends thereof being adjacent to a diffusion layer 32.

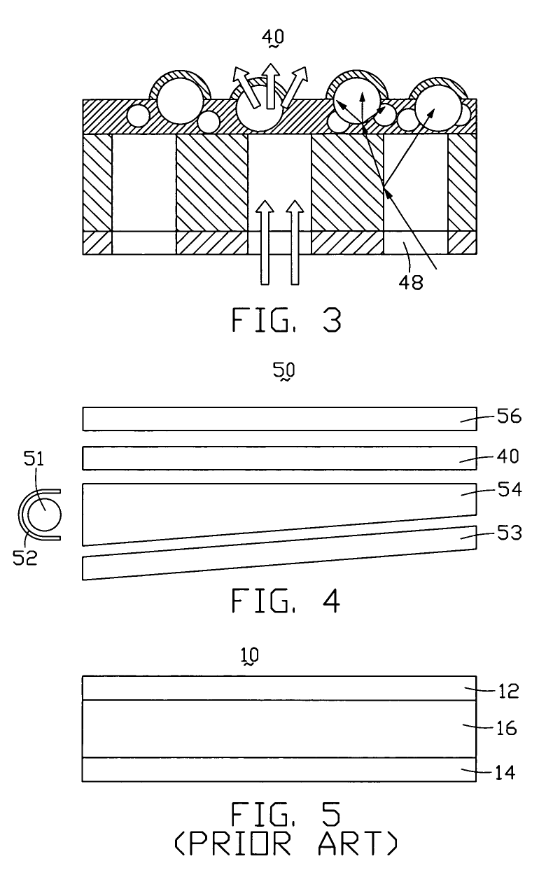

FIG. 3 is a schematic, side cross-sectional view of a diffusion plate 40 according to a third embodiment of the present invention. The diffusion plate 40 is similar to the diffusion plate 20 of FIG. 1. However, through holes 48 are cylindrical or columnar.

FIG. 4 is a schematic, side cross-sectional view of a backlight module 50 employing, for example, the diffusion plate 40 of the third embodiment. The backlight module 50 includes a reflection plate 53, a light guide plate 54, the diffusion plate 40, and an enhanced plate 56, in that order from bottom to top. A light source 51 and a light source cover 52 are disposed adjacent to an end surface of the light guide plate 54.

Light beams emitted by the light source 51 pass through the light guide plate 54 to the diffusion plate 40. A portion of the light beams propagating directly through the through holes 48 is not subject to absorption within the diffusion plate 40. This increases the overall utilization of light beams and the brightness of the backlight module 50.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A diffusion plate, comprising:
a substrate; and
a diffusion layer disposed at a surface of the substrate;
wherein the substrate defines a plurality of through holes terminating at the diffusion layer.

2. The diffusion plate as claimed in claim 1, wherein the through holes are cone-shaped.

3. The diffusion plate as claimed in claim 2, wherein diameters of ends of the through holes adjacent to the diffusion layer are larger than corresponding diameters of opposite ends of the through holes.

4. The diffusion plate as claimed in claim 1, wherein the through holes are cylindrical or columnar.

5. The diffusion plate as claimed in claim 1, further comprising an anti-electrostatic layer disposed at a surface of the substrate opposite to the diffusion layer.

6. The diffusion plate as claimed in claim 5, wherein the through holes are also defined in the anti-electrostatic layer.

7. A backlight module, comprising:
a light guide plate having a light incident surface and a light emitting surface;
a light source disposed adjacent to the incident surface; and
a diffusion plate disposed adjacent to the light emitting surface,
the diffusion plate comprising:
a substrate defining a plurality of through holes; and
a diffusion layer disposed at a surface of the substrate.

8. The diffusion plate as claimed in claim 7, wherein the through holes are cone-shaped.

9. The diffusion plate as claimed in claim 8, wherein diameters of ends of the through holes adjacent to the diffusion layer are greater than corresponding diameters of opposite ends of the through holes.

10. The diffusion plate as claimed in claim 7, wherein the through holes are cylindrical or columnar.

11. The diffusion plate as claimed in claim 7, further comprising an anti-electrostatic layer disposed at a surface of the substrate opposite to the diffusion layer.

12. The diffusion plate as claimed in claim 11, wherein the through holes are also defined in the anti-electrostatic layer.
